(19) United States
(12) Patent Application Publication
(10) Pub. No.: US 2026/0147110 A1
(43) Pub. Date: May 28, 2026

(54) CONFIGURATION OF ROUND-TRIP TIME MEASUREMENTS FOR POSITIONING

(71) Applicant: Sony Group Corporation, Tokyo (JP)

(72) Inventors: Basuki PRIYANTO, Lund (SE); Yujie ZHANG, Lund (SE); Jose FLORDELIS, Lund (SE)

(21) Appl. No.: 19/124,102

(22) PCT Filed: Oct. 24, 2023
(86) PCT No.: PCT/EP2023/079633

§ 371 Date: Apr. 24, 2025

(30) Foreign Application Priority Data
Nov. 4, 2022 (SE) 2251283-4

(51) Int. Cl. G01S 13/76; H04W 64/00

(52) U.S. Cl. CPC G01S 13/765; H04W 64/00

(57) ABSTRACT

Claims disclose a method, performed by a first communication node (320) of a communication network, for supporting round-trip time, RTT, measurements for positioning, the method comprising obtaining a message (341) indicative of a timing target for transmitting a second location reference signal (302) in relation to a communication of a first location reference signal (301); receiving the first location reference signal (301; 401; 501) at a first receiving point in time (t_321), and transmitting the second location reference signal (302) at a second transmitting point in time (t_322) in accordance with the timing target. Further claims, disclose a first communication node, a second communication node, and a method performed by a second communication node.

### TECHNICAL FIELD

Various examples generally relate to methods facilitating round-trip time measurements for positioning.

### BACKGROUND

Measuring the round-trip time (RTT) of location reference signals (LRS) has been proven to be a useful method to determine the position of a wireless device (or user equipment, UE) by determining the distance of the UE from one or more access nodes (AN) of a communication network, wherein the communication network comprises a plurality of communication nodes, including the AN and the UE, communicating in accordance with a predefined protocol.

The accuracy of an RTT measurement may depend on the clock signal used by the individual communication nodes participating in the RTT measurement. Clocks of different communication nodes may not always be in synchronization with each other and/or experience different clock drifts.

### SUMMARY

There may be a need for techniques allowing for more accurate RTT measurements. Said need has been addressed with the subject matter of the independent claims. Advantageous embodiments are described in the dependent claims.

Examples disclose a method, performed by a first communication node of a communication network, for supporting round-trip time measurements for positioning, the method comprising obtaining a message indicative of a timing target for transmitting a second location reference signal in relation to a communication of a first location reference signal; receiving the first location reference signal at a first receiving point in time; and transmitting the second location reference signal at a second transmitting point in time in accordance with the timing target.

Additionally, examples disclose a method, performed by a second communication node of a communication network, for supporting round-trip time measurements for positioning, the method comprising providing, to a first communication node, a message indicative of a timing target between a communication of a first location reference signal and a transmission of a second location reference signal.

Further, examples disclose a first communication node of a communication network, the first communication node comprising control circuitry, wherein the control circuitry is configured to perform the aforementioned method.

Moreover, examples disclose a second communication node of a communication network, the second communication node comprising control circuitry, wherein the control circuitry is configured to perform the aforementioned method.

### BRIEF DESCRIPTION OF THE DRAWINGS

FIG. 1 schematically illustrates an RTT measurement for positioning.

FIG. 2 illustrates communication between a first and a second communication node.

FIG. 3 illustrates a method for supporting RTT measurements for positioning.

FIG. 4 illustrates a method for supporting RTT measurements for positioning.

FIG. 5 illustrates a method for supporting RTT measurements for positioning.

FIG. 6 illustrates a method for supporting RTT measurements for positioning.

FIG. 7 illustrates a method for supporting RTT measurements for positioning.

FIG. 8 illustrates a selection of resources for supporting RTT measurements.

FIG. 9 illustrates a selection of resources for supporting RTT measurements.

### DETAILED DESCRIPTION

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions and/or methods as disclosed.

In the following, examples of the disclosure will be described in detail with reference to the accompanying drawings. It is to be understood that the following description of examples is not to be taken in a limiting sense. The scope of the disclosure is not intended to be limited by the examples described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

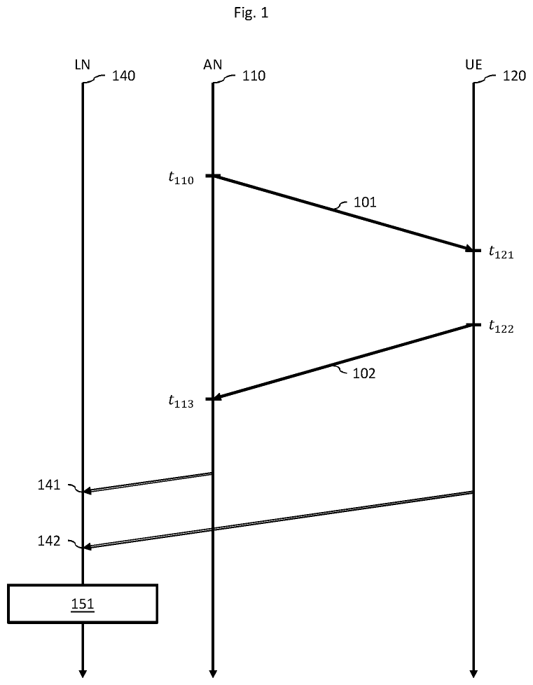

FIG. 1 illustrates an RTT measurement for positioning. The RTT measurement involves communication between a location server node (LN) 140, an AN 110 and a UE 120. In some examples, the LN may be implemented by a location management function (LMF). In some scenarios, the AN may be implemented by a gNB. In further scenarios, the AN may be implemented by a TRP. The LN 140, the AN 110 and the UE 120 may be part of a communication network. The communication network may comprise a plurality of communication nodes, including the AN 110 and the UE 120, communicating in accordance with a predefined protocol. The predefined protocol may be a protocol defined by the Third Generation Partnership Project (3GPP).

The AN 120 transmits a first location reference signal (LRS) 101 at a point in time t₁₁₀. The first LRS may be a downlink positioning signal (DL-PRS). The UE 120 receives the first LRS 101 at a point in time t₁₂₁. In response to receiving the first LRS 101, the UE 120 transmits a second LRS 102 at a point in time t₁₂₂. The second LRS 102 may be an uplink sounding reference signal (UL-SRS). The AN 110 receives the second LRS 102 at a point in time t₁₁₃. The AN 110 provides a message 141 indicative of the time interval t₁₁₃-t₁₁₀ to the LN 140. The time interval t₁₁₃-t₁₁₀ may also be called an AN Rx-Tx time difference. The message 141 may be provided to the LN 140 using an NRPPa protocol as specified in 3GPP TS 38.455 v17.2.0 Likewise, the UE 120 provides a message 142 indicative of the time interval t₁₂₂-t₁₂₁ to the LN 140. The time interval t₁₂₂-t₁₂₁ may also be called a UE Tx-Rx time difference. The UE Rx-Tx time difference may be due to the UE 120 having to wait for UL resources becoming available for transmitting the second location reference signal 102. In particular, the UE 120 may have to align the start of the transmission of the second location reference signal 102 with the start of an UL slot. The message 142 may be provided using an LTE positioning protocol (LPP) as specified in 3GPP TS 37.355 v17.2.0. Afterwards, the LN 142 may calculate the RTT which is indicative of two times the distance in time t_{range} between the AN 110 and the UE 120 as RTT=2·t_{range}=(t₁₂₁-t₁₁₀)+(t₁₃-t₁₂₂)=(t₁₁₃-t₁₁₀)−(t₂₂₂-t₁₂₁) as indicated with box 151.

Hence, the UE 120 performs the following actions. The UE 120 measures first reception point in time t₁₂₁ of the received first LRS, it transmits a second LRS, and it provides a message indicative of the time interval t₁₂₂-t₁₂₁, i.e., the transmission time t₁₂₂ of the second LRS 102 relative to the reception time t₁₂₁ of the first LRS 101.

Channel access procedures for downlink and uplink based multi-RTT positioning techniques are disclosed in 3GPP TR 38.305 v17.2.0.

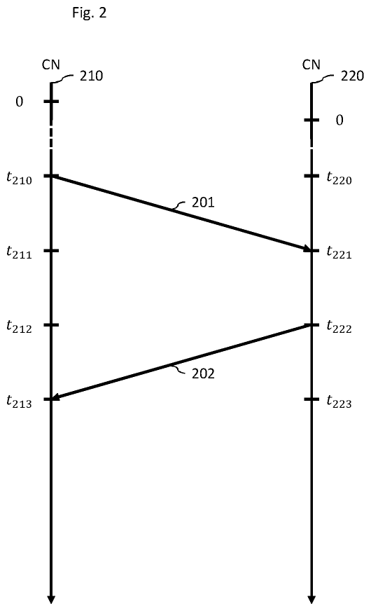

Generally, it is also possible to determine the distance in time t_{range} between the AN 110 and the UE 120 using TOA measurements, i.e. measuring the time interval t₁₂₁-t₁₁₀=t_{range}. However, using RTT measurements instead of TOA measurements for positioning may be advantageous as will be explained below with reference to FIG. 2.

FIG. 2 illustrates communication between first communication node (CN) 220 and a second CN 210 of a communication network. The communication network may comprise a plurality of CNs, including the first CN 220 and the second CN 210, communicating in accordance with a predefined protocol. The predefined protocol may be a protocol defined by 3GPP.

The first CN 220 and the second CN 210 may each use its own clock for measuring the point in time of transmission or reception of a signal. The clock of the first CN 220 and the clock of the second CN 210 may not be perfectly synchronized with each other. In particular, there may be an offset between the clock of the first CN 220 and the clock of the second CN 210 as indicated in FIG. 2.

The offset between the clocks would influence the accuracy of a range in time t_{range} measurement between the first CN 220 and the second CN 210 based on a TOA measurement of a first LRS 201, i.e. t_{range}=t₂₂₁-t₂₁₀, because t₂₂₁≠t₂₁₁ (and t₂₂₀≠t₂₁₀). In an RTT measurement using the first LRS 201 and the second LRS 202 for determining

$${t}_{range} = \frac{1}{2} * RTT = \frac{1}{2} \cdot ( ( {t}_{213} - {t}_{210} ) - ( {t}_{222} - {t}_{221} ) )$$

the offset error cancels out.

Hence, using RTT measurements for positioning may be particularly useful for CNs not being perfectly synchronized, in particular for CNs communicating with each other using sidelink (SL) communication.

In addition to offset errors, the clocks of the CNs participating in an RTT measurement may experience random clock drifts. Larger values of t₂₂₁-t₂₂₂ and/or t₂₁₀-t₂₁₃ may increase the timing error induced by the clock drifts and, hence, reduce the positioning accuracy.

Thus, there is a need for improving positioning techniques, in particular for CNs communicating with each other using SL communication.

Thus, examples disclose a method, performed by a first CN of a communication network, for supporting RTT measurements for positioning, wherein the method comprises obtaining a message indicative of a timing target for transmitting a second LRS in relation to a communication of a first location reference signal, receiving the first location reference signal at a first receiving point in time, and transmitting a second location reference signal at a second transmitting point in time in accordance with the timing target.

Further examples disclose a method, performed by a second CN of a communication network, for supporting RTT measurements for positioning, wherein the method comprises providing a message indicative of a timing target for transmitting a second LRS in relation to a communication of a first location reference signal.

Aspects of SL communication, in particular with respect to vehicle-to-everything (V2X) communication, have been specified in 3GPP TR 37.985 v17.1.1 clause 5.2.1 and 6.3. For SL communication, two channel access modes (modes 1 and 2) for the resource selection are specified. In mode 1, the AN (i.e., the gNB) assigns and manages the SL resources for V2X communication under the NR Uu interface. This implies that UEs must be in network coverage when operating in mode 1. Furthermore, depending on the transmission block (TB) type, mode 1 has two variants: dynamic grant (DG) and semi-persistent scheduling grant (SG). DG may be used for the transmission of a single TB and SG may be used for periodic transmissions. In mode 2, UEs may autonomously select their SL resources from a resource pool by sensing and selection. To avoid resource collision, UEs operating in mode 2 first need to sense the resource pool by measuring the power in each sub-channel in a sensing window and filtering out occupied sub-channels. The candidate sub-channels left from this step may undergo further selection in a resource selection phase. Within a resource selection window, the transmitting UE further selects one or more sub-channels to be used for TB transmission.

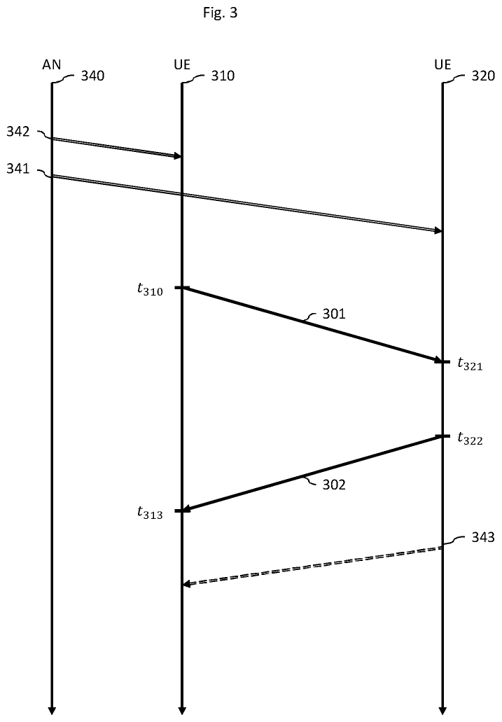

FIG. 3 illustrates a method for supporting RTT measurements for positioning in a communication network. The communication network comprises a plurality of communication nodes including a first communication node 320, a second communication node 340 and a first location reference signal transmitting communication node 310. The communication nodes of the communication network may communicate in accordance with a predefined protocol. In particular, the communication nodes of the communication network may use mode 1 SL communication as specified hereinbefore. In the example of FIG. 3, the first communication node 320 may be implemented by a UE, the second communication node 340 may be implemented by an AN, and the first location reference signal transmitting communication node 310 may be implemented by a UE.

The first communication node 320 obtains, from the second communication node 340, a message 341 indicative of a timing target for transmitting a second location reference signal 302 in relation to a communication of a first location reference signal 301. The first location reference signal transmitting communication node 310 transmits the first location reference signal 301 at a first transmitting point in time t₃₁₀. The first communication node 320 receives the first location reference signal 301 at a first receiving point in time t₃₂₁ and transmits the second location reference signal 302 at a second transmitting point in time t₃₂₂ in accordance with the timing target. The first location reference signal transmitting communication node 310 receives the second location reference signal 302 at a second receiving point in time t₃₁₃.

The first communication node 320 may optionally provide, in particular to the first location reference signal transmitting communication node 310, a message 343 indicative of a time difference between the second transmitting point in time t₃₂₂ and the first receiving point in time t₃₂₁. Based on the first transmitting point in time t₃₁₀, the second receiving point in time t₃₁₃ and the time difference between the second transmitting point in time t₃₂₂ and the first receiving point in time t₃₂₁, the first location reference signal transmitting communication node 310 may derive the RTT.

The timing target for transmitting the second location reference signal 302 in relation to a communication of a first location reference signal 301 may improve the accuracy of an RTT measurement for positioning. In particular, the timing target may reduce the influence of clock drifts on the positioning accuracy. In some scenarios, the first communication node 320 and the first location reference signal transmitting communication node 310 may move relative to each other with a relative velocity. Thus, the first location reference signal 301 and the second location reference signal 302 may travel different distances. Setting a timing target, in particular a relatively short timing target, for transmitting the second location reference signal 302 may allow for reducing the influence of the relative velocity on the positioning accuracy.

In some examples, the timing target defines a time window for transmitting the second location reference signal 302 in relation to the communication of the first location reference signal 301. For example, the time window may specify a maximum (and optionally a minimum) time in which the second location reference signal 302 is to be transmitted by the first communication node 320.

In some examples, the timing target defines an offset of the second transmitting point in time t₃₂₂ with respect to communication of the first location reference signal 301.

In some scenarios, the timing target may be defined in relation to the transmission of the first location reference signal, i.e. in relation to the first transmission point in time t₃₁₀. Other scenarios may prescribe defining the timing target in relation to the reception of the first location reference signal, i.e. in relation to the first receiving point in time t₃₂₁.

In case the timing target defines an offset of the second transmitting point in time t₃₂₂ with respect to the first receiving point in time t₃₂₁, providing the message indicative of the time difference between the second transmitting point in time t₃₂₂ and the first receiving point in time t₃₂₁ may be omitted as said information will already be available for the communication node deriving the RTT, as it has already defined such a parameter in the timing target.

For example, the first location reference signal transmitting communication node 310 may also obtain from the second communication node 340 a message 342 indicative of the timing target. Thus, usage of limited radio resources may be reduced.

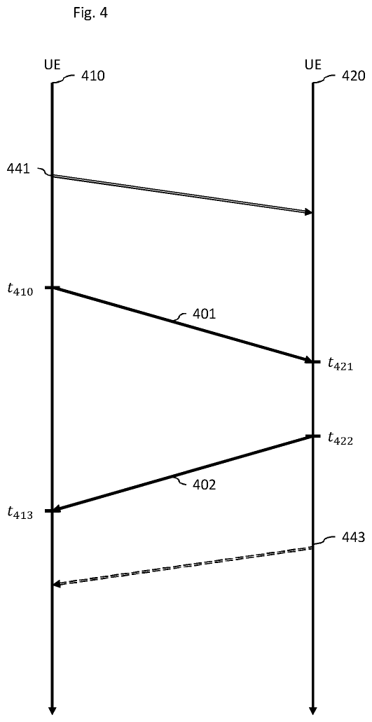

FIG. 4 illustrates another method for supporting RTT measurements for positioning in a communication network. The communication network comprises a plurality of communication nodes including a first communication node 420 and a second communication node 410. The communication nodes of the communication network may communicate in accordance with a predefined protocol. For example, the communication nodes of the communication network may use mode 2 SL communication as specified above. The first communication node 410 and the second communication node 420 may both be implemented by a UE.

The first communication node 420 obtains, from the second communication node 410, a message 441 indicative of a timing target for transmitting a second positioning signal 402 in relation to a communication of a first location reference signal 401. The second communication node 410, which may also be considered a first location reference signal transmitting communication node, transmits the first location reference signal 401 at a first transmitting point in time t₄₁₀. The first communication node 420 receives the first location reference signal 401 at a first receiving point in time t₄₂₁ and transmits the second location reference signal 402 at a second transmitting point in time t₄₂₂ in accordance with the timing target. The second communication node 410 receives the second location reference signal 402 at a second receiving point in time t₄₁₃.

The first communication node 420 may optionally provide, in particular to the second communication node 410, a message 443 indicative of a time difference between the second transmitting point in time t₄₂₂ and the first receiving point in time t₄₂₁. Based on the first transmitting point in time t₄₁₀, the second receiving point in time t₄₁₄ and the time difference between the second transmitting point in time t₄₂₂ and the first receiving point in time t₄₂₁, the second communication node 410 may derive the RTT.

The timing target for transmitting the second location reference signal 402 in relation to the communication of the first location reference signal 401 may improve the accuracy of an RTT measurement for positioning. In particular, the timing target may reduce the influence of clock drifts on the positioning accuracy. According to examples, the first communication node 420 and the second communication node 410 may move relative to each other with a relative velocity. Thus, the first location reference signal 401 and the second location reference signal 402 may travel different distances. Setting a timing target, in particular a relatively short timing target, for transmitting second location reference signal 402 may allow for reducing the influence of the relative velocity on the positioning accuracy.

In some scenarios, the timing target defines a time window for transmitting the second location reference signal 402 in relation to communication of the first location reference signal 401. For example, the time window may specify a maximum (and optionally a minimum) time in which the second location reference signal 402 is to be transmitted by the first communication node 420.

According to some scenarios, the timing target defines an offset of the second transmitting point in time t₄₂₂ with respect to communication of the second communication node 410.

In some examples, the timing target may be defined in relation to the transmission of the first location reference signal, i.e. in relation to the first transmission point in time t₄₁₀. Other scenarios may prescribe defining the timing target in relation to the reception of the first location reference signal, i.e. in relation to the first receiving point in time t₄₂₁.

In case the timing target defines an offset of the second transmitting point in time t₄₂₂ with respect to the first receiving point in time t₄₂₁, providing the message indicative of the time difference between the second transmitting point in time t₄₂₂ and the first receiving point in time t₄₂₁ may be omitted as said information will already be available for the communication node deriving the RTT. Thus, usage of limited radio resources may be reduced.

In some examples, the first communication node 410 may not be able to transmit the second LRS in accordance with the timing target. In such a scenario, the first communication node 410 may still provide a message indicative of the time difference between the second transmitting point in time t₄₂₂ and the first receiving point in time _t₄₂₁ to allow for deriving the RTT. The time difference may also be indicative relative to the timing target, for example, how much longer the time difference is with respect to the intended offset.

In FIG. 5, a still further method for supporting RTT measurement for positioning in a communication network is illustrated. The communication network comprises a plurality of communication nodes including a first communication node 520 and a second communication node 510. The communication nodes of the communication network may communicate in accordance with a predefined protocol. For example, the communication nodes of the communication network may use mode 2 SL communication as specified above. The first communication node 510 and the second communication node 520 may both be implemented by a UE.

As explained with respect to FIG. 2, the clocks of the first communication node 520 and the second communication node 510 may not be synchronized or at least not perfectly synchronized. Hence, t_{51?} refers to a point in time with reference to the clock of the second communication node 510 and t_{52?} refers to a point in time with reference to the clock of the first communication node 520.

The first communication node 520 obtains, from the second communication node 510, a message 541 indicative of a timing target for transmitting a second positioning signal 502 in relation to communication of a first location reference signal 501. The second communication node 501 transmits the first location reference signal 501 at a first transmitting point in time t₅₁₀. The first transmitting point in time t₅₁₀ may correspond to the start of a first symbol. The first communication node 520 receives the first location reference signal 501 at a first receiving point in time t₅₂₁.

The timing target may prescribe transmitting the second location reference signal 502 at a second transmitting point in time t₅₂₂ defined as an offset with respect to the first receiving point in time t₅₂₁. The offset may be expressed in form of a number of symbols, e.g., N symbols.

At 551, the first communication node 510 may estimate the signal propagation delay signal propagation delay d=t₅₂₁-t₅₂₀ and modify the second location reference signal to be transmitted in the N-th symbol by applying the delay d. This may be done in the frequency domain. The modified second location reference signal sequence S₅₀₂′ may be expressed as

$${S}^{′} ( t ) = IFT ( FT ( S ( t ) ) \cdot {e}^{- i 2 π \frac{d}{{T}_{c}} f} ) ,$$

where S corresponds to the unmodified second location reference signal sequence in time domain, IFT(*) correspond to an inverse Fourier transformation operation and FT (*) to a Fourier transformation, and Tc corresponds to the sampling time.

The first communication node 520 may then transmit the second location reference signal 502 with the modified second location reference signal sequence S′(t) in the N-th symbol. The second communication node 510 receives the second location reference signal 502 at a second reception point in time t₅₁₃ and may calculate the RTT=t₅₁₃-t₅₁₀−N T_{symb}, wherein T_{symb} corresponds to the symbol duration such as an OFDM symbol duration.

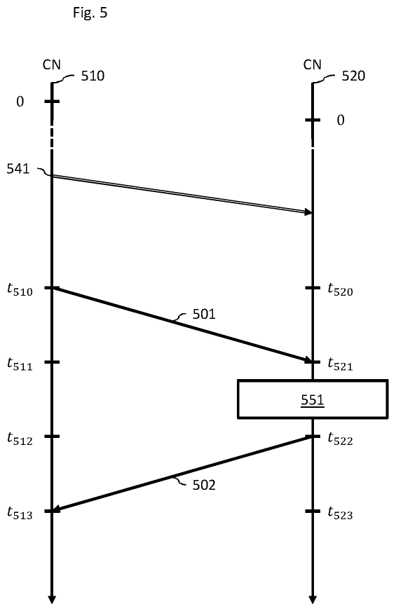

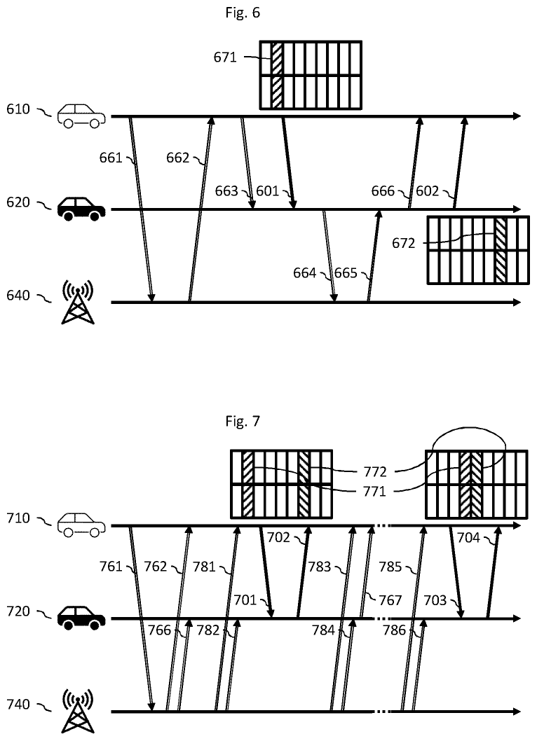

FIG. 6 illustrates a method for supporting RTT measurements for positioning in a communication network. The communication network comprises a plurality of communication nodes including a first communication node 620, a second communication node 640 and a first location reference signal transmitting communication node 610. The first communication node 620 and the first location reference signal transmitting communication node 610 may be implemented by UEs and the second communication node 640 may be implemented by an AN of the communication network. The communication nodes of the communication network may communicate in accordance with a predefined protocol. For example, the communication nodes of the communication network may use mode 1 SL communication as specified above. More specifically, a dynamic grant (DG) procedure may be used. FIG. 6 illustrates in particular a mechanism for allocating resources for communicating a first location reference signal 601 and for communicating a second location reference signal 602.

The second communication node 640 may obtain, from the first location reference signal transmitting communication node 610, a message 661 indicative of a request to allocate resources 671 for communicating the first location reference signal 601. The second communication node 640 may provide, to the first location reference signal transmitting communication node 610, a message 662 indicative of the resources 671 allocated for communicating the first positioning signal 601. Heretofore, downlink control information (DCI) signaling may be used. The first location reference signal transmitting communication node 610 may provide, to the first communication node 620, a message 663 indicative of a timing target for transmitting the second location reference signal 602 in relation to the communication of the first location reference signal 601. The message 663 may further trigger the first communication node 620 to measure a first receiving point in time, at which the first positioning signal 601 is received. The message 663 may be provided to the first communication node 620 using sidelink control information (SCI). The first location reference signal transmitting communication node 610 may transmit the first location reference signal 601 using the resources 671 allocated by the second communication node 640 for communicating the first location reference signal 601. A single TB may be used for transmitting the first location reference signal 601. After reception of the first location reference signal 601, the first communication node 620 may provide, to the second communication node 640, a message 664 indicative of a request to allocate resources 672 for communicating the second location reference signal 602. The second communication node 640 may provide, to the first communication node 620, a message 665 indicative of the resources 672 allocated for communicating the second location reference signal 602. The message 665 may be provided using DCI signaling. The first communication node 620 may provide, to the first reference signal transmitting communication node 610, a message 666 leading the first location reference signal transmitting node 610 to measure a second receiving point in time, at which the second location reference signal 602 is received. Afterwards, the first communication node 620 may transmit the second location reference signal 602 using the resources 672 allocated by the second communication node 640.

FIG. 7 illustrates further aspects of supporting RTT measurements for positioning in a communication network. The communication network comprises a plurality of communication nodes including a first communication node 720, a second communication node 740 and a first location reference signal transmitting communication node 710. The first communication node 720 and the first location reference signal transmitting communication node 710 may be implemented by UEs and the second communication node 740 may be implemented by an AN of the communication network. The communication nodes of the communication network may communicate in accordance with a predefined protocol. For example, the communication nodes of the communication network may use mode 1 SL communication as specified above.

The second communication node 740 may obtain, from the first location reference signal transmitting communication node 710, a message 761 indicative of a request to allocate resources 771 for communicating first positioning signals 701, 703 and to allocate resources 772 for communicating second positioning signals 702, 704. The second communication node 740 may have full knowledge of the already occupied resources. Accordingly, the second communication node 740 may optimize allocation of resources 771 and 772 for the purpose of RTT measurements. For example, the second communication node 740 may allocate contiguous resources for communicating the first and second positioning signals. The resources for communicating the first positioning signals 701, 703 and the second positioning signals 702, 704 may be allocated jointly. In contrast to the scenario described with respect to FIG. 6, the resources 772 for communicating the second positioning signal 702 are allocated before the first communication node 720 receives the first positioning signal 701. Thus, a time interval between receiving the first location reference signal 701 and transmitting the second location reference signal 702 may be shorter leading to an improved accuracy of an RTT measurement. In particular, the time interval between receiving the first location signal 701 and transmitting the second location reference signal 702 may be shorter than the time interval between receiving in the first location reference signal 601 and transmitting the second location reference signal 602 as shown in FIG. 6, because no extra signaling is required between the two location reference signal transmissions.

The second communication node 740 may provide messages 762, 766, to the first positioning signal transmitting node 710 and the first communication node 720, respectively, indicative of the resources 771 and 772. The messages 762, 766 may be transmitted using radio resource control (RRC) signaling. The messages 762, 766 may be indicative of several preconfigured sets of resources 771 and 772.

The second communication node 740 may provide messages 781, 782 to the first positioning signal transmitting communication node 710 and the first communication node 720 activating RTT measurements. The message 781, 782 may be provided using lower layer signaling. For example, the message 781, 782 may be provided using DCI signaling. The message 781, 782 may be indicative of the preconfigured set of resources 771, 772 to be used for performing the RTT measurements, i.e., communicating the first location reference signal 701 and the second location reference signal 702. The lower layer signaling may address each UEs individually (unicast) or via a groupcast, in which the DCI may be scrambled with a specific radio network temporary identifier (RNTI), such as an RTT RNTI.

Afterwards, the first location reference signal transmitting communication node 710 may transmit the first location reference signal using the resources 771 of the preconfigured set. The first communication node 720 receives the first location reference signal 701 and transmits the second location reference signal 702 using the resources 772 of the preconfigured set.

The second communication node 740 may provide messages 783, 784 to the first positioning signal transmitting communication node 710 and the first communication node 720 deactivating RTT measurements.

The second communication node 740 may provide, to the first positioning signal transmitting communication node 710, a message 767 indicative of a time difference between the second transmitting point in time, at which the second location reference signal 702 has been transmitted, and a first receiving point in time, at which the first location reference signal 701 has been received.

Before deactivating the RTT measurements, not only one pair of a first location reference signal 701 and a second location reference signal 702 may have been communicated, but several pairs. In particular, several first location reference signals 701 may have been communicated periodically followed by a respective communication of a second location reference signal 702.

The second communication node 740 may provide messages 785, 786 for reactivating the RTT measurements. The message 785, 786 may be indicative of a preconfigured set of resources for communicating the first location reference signal 703 and the second location reference signal 704 being different from the set of resources for communicating the first location reference signal 701 and the second location reference signal 702.

In some scenarios, a first communication node (e.g., the communication node 420) and a second communication node (e.g., the communication node 410) of a communication network may operate in mode 2 as described above. When operating in mode 2, the second communication node may assist the first communication node in configuring resources for communicating the second location reference signal. In particular, the second communication node may have full control of the configuration. The second communication node may be configured for sensing and/or selecting and/or allocating the resources for communicating the second location reference signal. The second communication node may provide, to the first communication node, a message indicative of resources for communicating the second location reference signal.

In some examples, the second communication node may provide, to the first communication node, a message indicative of a set of candidate resources for communicating the second location reference signal. The first communication node may then select the resources among the set of candidate resources. The second communication node may assist the first communication node in finding resources for transmitting the second location reference signal in an inter-UE-coordination (IUC)-like operation.

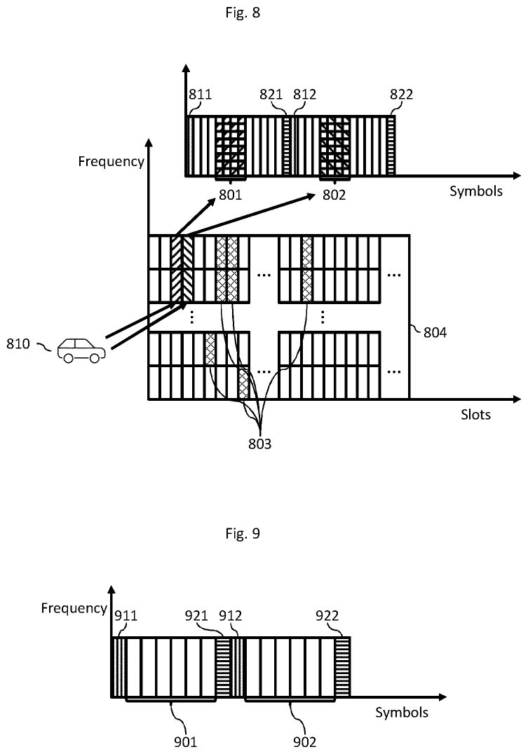

The second communication node 810 may measure the power in each sub-channel in a sensing window 804 as shown in FIG. 8 and filter out occupied resources 803. The candidate sub-channels left from this step may undergo further selection in a resource selection phase. The second communication node 810 may select the (candidate) resources for both communicating the first location reference signal and communicating the second location reference signal. Preferably, the second communication node 810 may select resources 801, 802 in two consecutive slots for communicating the first location reference signal and communicating the second location reference signal. The slots may start with an automatic gain control (AGC) symbol 811, 812 and end with a guard symbol 821, 822. The resources 801, 802 may be selected to use the same frequency pattern as indicated in FIG. 8. For example, the second communication node may use the same combSize and the same combOffset, as specified in 3GPP TS 38.211 v17.3.0 for both the first location reference signal and the second location reference signal, but in different time slots.

As explained before, the first communication node may obtain a message indicative of a set of candidate resources for communicating the second location reference signal. The resource to be actually used for communicating the second location reference signal by the first communication node may be preassigned. In other scenarios, the first communication node may autonomously select the resource to be used based on its UE-ID. In some examples, the first communication node may perform a random selection among the candidate resources. For examples may prescribe that the first communication node performs sensing to derive the resource to be actually used for communicating the second positioning symbol.

As illustrated in FIG. 9, the communication of the first location reference signal and the second location reference signal may be performed at the symbol level. For example, symbols 901 may be used to communicate the first location reference signal and symbols 902 may be used to communicate the second location reference signal. The slots may start with an AGC symbol 911, 912 and end with a guard symbol 921, 922. The guard symbols may allow the communication nodes to switch from receiving signals to transmitting signals (and vice-versa).

In some scenarios, the first communication node, i.e., the communication node receiving the first location reference signal and transmitting the second location reference signal may derive the (candidate) resources for transmitting the first location reference signal and transmitting the second location reference signal.

In other words, the communication node deriving the (candidate) resources may select to be the communication node transmitting the first location reference signal or the communication node receiving the first location reference signal. This may enhance the flexibility for deriving the (candidate) resources for communicating the first location reference signal and the second location reference signal.

In some examples, the first communication node receives a message indicative of multiple resources (occasions) for communicating the first location reference signal. The first communication node monitors the multiple resources to detect the first location reference signal. Once the first communication node has detected the first location reference signal, the first communication node may stop monitoring the remaining occasions. If the first communication node cannot detect the first location reference signal, the first communication node may continue to monitor the remaining occasions.

In some scenarios, the first communication node may not be able to transmit the second location reference signal in accordance with the timing target. In such a scenario, the first communication node may perform a fallback option. In particular, the first communication node may perform a double-sided RTT measurement. Double-sided RTT measurements may prescribe the transmission of a first positioning signal, a second location reference signal and a third location reference signal. The third location reference signal may be required to correct a clock drift at both communication nodes.

The timing target as described herein may be selected based on a clock accuracy of the communication nodes. In other examples, the timing target may be selected based on a relative velocity of the first communication node with respect to a first location reference signal transmitting communication node.

Summarizing, at least the following EXAMPLES have been described above:

EXAMPLE 1. A method, performed by a first communication node (320, 420, 520) of a communication network, for supporting round-trip time, RTT, measurements for positioning, the method comprising
obtaining a message (341; 441; 541) indicative of a timing target for transmitting a second location reference signal (302; 402; 502) in relation to a communication of a first location reference signal (301; 401; 501);
receiving the first location reference signal (301; 401; 501) at a first receiving point in time (t₃₂₁; t₄₂₁; t₅₂₁);
transmitting the second location reference signal (302; 402; 502) at a second transmitting point in time (t₃₂₂; t₄₂₂; t₅₂₂) in accordance with the timing target.

EXAMPLE 2. The method of EXAMPLE 1,

wherein the timing target defines a time window for transmitting the second location reference signal (302; 402; 502).

EXAMPLE 3. The method of EXAMPLE 1,

wherein the timing target defines an offset of the second transmitting point in time (t₃₂₂; t₄₂₂; t₅₂₂) with respect to the communication of the first location reference signal (302; 402; 502).

EXAMPLE 4. The method of any one of EXAMPLES 1 to 3,

wherein the message (341; 441; 541) indicative of the timing target for transmitting the second location reference signal (302; 402; 502) is indicative of the timing target in relation to the first receiving point in time (t₃₂₁; t₄₂₁; t₅₂₁).

EXAMPLE 5. The method of any one of EXAMPLES 1 to 3,

wherein the message (341, 441, 541) indicative of the timing target for transmitting the second location reference signal (302; 402; 502) is indicative of the timing target in relation to a transmission of the first location reference signal (301; 401; 501) at a first transmitting point in time (t₃₁₀; t₄₁₀; t₅₁₀).

EXAMPLE 6. The method of any one of EXAMPLES 1 to 5, further comprising
providing a message (343, 443) indicative of a time difference between the second transmitting point in time (t₃₂₂; t₄₂₂) and the first receiving point in time (t₃₂₁; t₄₂₁).

EXAMPLE 7. The method of any one of EXAMPLES 1 to 6, further comprising at least one of:
obtaining a message indicative of one or more resources allocated for transmitting the second location reference signal (302; 402; 502);
obtaining a message indicative of one or more resources allocated for receiving the first location reference signal (301; 401; 501).

EXAMPLE 8. The method of EXAMPLE 7,
wherein the message (341; 441; 541) indicative of the timing target, is indicative of the resources allocated for receiving the first location reference signal (301; 401; 501) and/or the resources for transmitting the second location reference signal (302; 402; 502).

EXAMPLE 9. The method of any one of EXAMPLES 1 to 8, wherein the message (341; 441; 541) indicative of the timing target and/or the message indicative of the resources for transmitting the second location reference signal (302; 402; 502) is part of a sidelink control information, SCI, message.

EXAMPLE 10. The method of any one of EXAMPLES 1 to 9, further comprising
providing a message indicative of the first communication node (320; 420; 520) not being able to meet the timing target,
   wherein providing a message indicative of the first communication node (320; 420; 520) not being able to meet the timing target optionally comprises transmitting a third location reference signal.

EXAMPLE 11. A method, performed by a second communication node (340; 410; 510) of a communication network, for supporting round-trip time, RTT, measurements for positioning, the method comprising
providing, to a first communication node (320; 420; 520), a message (341; 441; 541) indicative of a timing target between a communication of a first location reference signal (301; 401; 501) and a transmission of a second location reference signal (302; 402; 502).

1. A method, performed by a first communication node of a communication network, for supporting round-trip time (RTT) measurements for positioning, the method comprising
obtaining a message indicative of a timing target for transmitting a second location reference signal in relation to a communication of a first location reference signal;
receiving the first location reference signal at a first receiving point in time:
transmitting the second location reference signal at a second transmitting point in time in accordance with the timing target.

2. The method of claim 1, wherein the timing target defines a time window for transmitting the second location reference signal.

3. The method of claim 1, wherein the timing target defines an offset of the second transmitting point in time with respect to the communication of the first location reference signal.

4. The method of claim 1, wherein the message indicative of the timing target for transmitting the second location reference signal is indicative of the timing target in relation to the first receiving point in time.

5. The method of claim 1, wherein the message indicative of the timing target for transmitting the second location reference signal is indicative of the timing target in relation to a transmission of the first location reference signal at a first transmitting point in time.

6. The method of claim 1, further comprising
providing a message indicative of a time difference between the second transmitting point in time and the first receiving point in time.

7. The method of claim 1, further comprising
obtaining a message indicative of one or more resources allocated for transmitting the second location reference signal.

8. The method of claim 1, further comprising
obtaining a message indicative of one or more resources allocated for receiving the first location reference signal.

9. The method of claim 7,
wherein the message indicative of the timing target, is indicative of the resources allocated for receiving the first location reference signal and/or the resources for transmitting the second location reference signal.

10. The method of claim 1, wherein the message indicative of the timing target and/or the message indicative of the resources for transmitting the second location reference signal is part of a sidelink control information, SCI, message.

11. The method of claim 1, further comprising
providing a message indicative of the first communication node not being able to meet the timing target.

12. The method of claim 11, wherein providing a message indicative of the first communication node not being able to meet the timing target comprises transmitting a third location reference signal.

13. A method, performed by a second communication node of a communication network, for supporting round-trip time (RTT) measurements for positioning, the method comprising
providing, to a first communication node, a message indicative of a timing target between a communication of a first location reference signal and a transmission of a second location reference signal.

14. The method of claim 13, wherein the timing target defines a time window for transmitting the second location reference signal.

15. The method of claim 13, wherein the timing target defines an offset of a second transmitting point in time for transmitting the second location reference signal.

16. The method of claim 13, wherein the message indicative of the timing target for transmitting the second location reference signal is indicative of the timing target in relation to a first receiving point in time at which the first location reference signal is received by the first communication node.

17. The method of claim 13, wherein the message indicative of the timing target for transmitting the second location reference signal is indicative of the timing target in relation to a transmission of the first location reference signal at a first transmitting point in time.

18. The method of claim 13, further comprising
obtaining a message indicative of a time difference between the second transmitting point in time and a or the first receiving point in time at which the first location reference signal is received by the first communication node.

19. The method of claim 13, further comprising
receiving, from the first communication device, the second location reference signal at a second receiving point in time.

20. The method of claim 13, further comprising
providing, to the first communication node, a message indicative of one or more resources allocated for transmitting the second location reference signal.

21-27. (canceled)
